(19) United States
(12) Patent Application Publication
(10) Pub. No.: US 2022/0156321 A1
(43) Pub. Date: May 19, 2022

(54) DISTANCE MEASUREMENT FOR TIME SERIES

(71) Applicant: Alibaba Group Holding Limited, Grand Cayman (KY)

(72) Inventors: Xiaomin Song, Issaquah (US); Qingsong Wen, Issaquah (US); Yan Li, Bellevue (US); Liang Sun, Bellevue (US)

(21) Appl. No.: 16/952,005

(22) Filed: Nov. 18, 2020

(51) Int. Cl. G06F 16/901

(52) U.S. Cl. CPC G06F 16/9024

(57) ABSTRACT

A time series distance estimation system may receive two time series and estimate a distance or a degree of dissimilarity between the two time series. The system may calculate a time warp function for the two time series, and perform a trend filtering alternately in a multi-level framework to further accelerate the speed of computation.

### BACKGROUND

Computation of dissimilarity or difference between two time series has been widely employed in a number of applications that involve computations of distance between time series, such as a time series similarity search, outlier detection, clustering, and classification, etc. Such computation of dissimilarity or difference between two time series may also be used in a number of different technical areas, which may include, but is not limited to, speech recognition, speaker recognition, machine learning, signal processing, robotics, economics and finance, bioinformatics, for example.

However, real-world time series data generally includes noises and outliers. These noises and outliers may bias distances between different time series, and may lead to a singularity problem where a single point in one time series is mapped to a subsection (i.e., multiple points) in another time series. Furthermore, existing methods of mapping corresponding points of two time series (or determining a dissimilarity or difference between the two time series) have the time complexity and the space complexity that are at least quadratic to the length of the time series, and thus are difficult to be applied in the analysis of long time series. Moreover, some existing methods may not be able to handle situations in which some data or points in one time series are missing as compared to another time series, and thus such methods fail to find a match for or fill in a part of a time series with respect to another time series. Without solving these issues, the existing methods of mapping two time series (or determining a dissimilarity or difference between the two time series) would unavoidably lead to higher computational and memory workloads, and thus limit applications thereof in the technical areas, such as speech recognition, machine learning, signal processing, robotics, etc., as described above.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment in which a time series distance estimation system may be used.

FIG. 2 illustrates the example time series distance estimation system in more detail.

FIG. 3 shows an example graph construction between two time series.

FIG. 4 shows an example method of handling missing values in time series in a multi-level framework.

FIG. 5 illustrates an example method of time series distance estimation.

### DETAILED DESCRIPTION

### Overview

As noted above, existing methods of mapping two time series (or determining a dissimilarity or difference between the two time series) suffer from a number of technical problems or drawbacks, such as distance biases due to the presence of noises and outliers, relatively high time and space complexities, missing data issues, etc., and thus have limited applications in the technical areas, such as speech recognition, speaker recognition, machine learning, signal processing, robotics, economics and finance, bioinformatics, etc.

This disclosure describes an example time series distance estimation system. In implementations, the time series distance estimation system may perform filtering, such as trend filtering (which may include, but is not limited to, a general temporal graph trend filtering, etc.), for a multivariate time series to estimate a true signal (or time series). In implementations, the time series distance estimation system may estimate or calculate a time warp function, and perform the trend filtering simultaneously or alternately. In implementations, the time series distance estimation system may learn the time warp function and perform the trend filtering simultaneously or alternately in a multi-level framework to further accelerate the speed of computation.

In implementations, the time series distance estimation system may receive two time series, and the two time series may include two signals that are obtained over different periods of time for an application and are compared to determine whether the two signals are considered to be identical or come from a same source. In implementations, the time series distance estimation system may recursively perform downsampling by a predetermined factor to obtain different levels of representations of the time series. Starting from the highest level of representation (i.e., lowest resolution), in implementations, the time series distance estimation system may estimate or calculate a time warp function for the two time series. Based on the estimated or calculated time warp function, the time series distance estimation system may then construct a weighted graph to map or pair-wise the two time series.

In implementations, after constructing the weighted graph for mapping or pair-wising the two time series, the time series distance estimation system may perform a temporal graph trend filtering using the weighted graph to update denoising estimates.

In implementations, the time series distance estimation system may iteratively or recursively calculate or estimate a time warp function in a next level of representation based on a time warp function that is calculated and obtained in a previous level of representation, thus reducing the computational complexity and increasing the speed of computation. Based on the newly calculated time warp function, the time series distance estimation system may construct a new weighted graph to map or pair-wise the two time series at the next level of representation, and perform a temporal graph trend filtering using the newly constructed weighted graph to update denoising estimates at the next level of representation. The time series distance estimation system may iteratively or recursively perform the above operations up to the lowest level of representation (i.e., the original highest resolution).

In implementations, the time series distance estimation system may further employ a unified framework in the multi-level framework to handle with missing data points in the time series. In implementations, the time series distance estimation system may adaptively exclude a missing block (i.e., missing data points) in one time series and a corresponding aligned counter block in another time series when calculating or estimating the time warp function.

After performing the above operations, the time series distance estimation system may obtain a final time warp function for the two time series at the lowest level of representation (i.e., the original highest resolution). The time series distance estimation system may then estimate or calculate a distance or a degree of dissimilarity between the two time series. Depending on the type of the two series (such as speech signals, robotic movements, etc.), the time series distance estimation system or another system (to which the calculated distance or degree of dissimilarity between the two time series is sent) may perform subsequent operations for an intended application (such as speech recognition, robotic error detection, etc.).

In implementations, functions described herein to be performed by the time series distance estimation system may be performed by multiple separate units or services. For example, a receiving service may receive data of time series, while a downsampling service may perform downsampling to obtain different levels of representations of the time series. Additionally, a calculation service may yield a time warp function for the two time series for a particular level, and a construction service may construct a weighted graph to map or pair-wise the two time series based on the calculated time warp function at that particular level. Moreover, a filtering service may perform a temporal graph trend filtering using the weighted graph to update denoising estimates.

Moreover, although in the examples described herein, the time series distance estimation system may be implemented as a combination of software and hardware implemented and distributed in multiple devices, in other examples, the time series distance estimation system may be implemented and distributed as services provided in one or more computing nodes over a network and/or in a cloud computing architecture.

The application describes multiple and varied embodiments and implementations. The following section describes an example framework that is suitable for practicing various implementations. Next, the application describes example systems, devices, and processes for implementing a time series distance estimation system.

### Example Environment

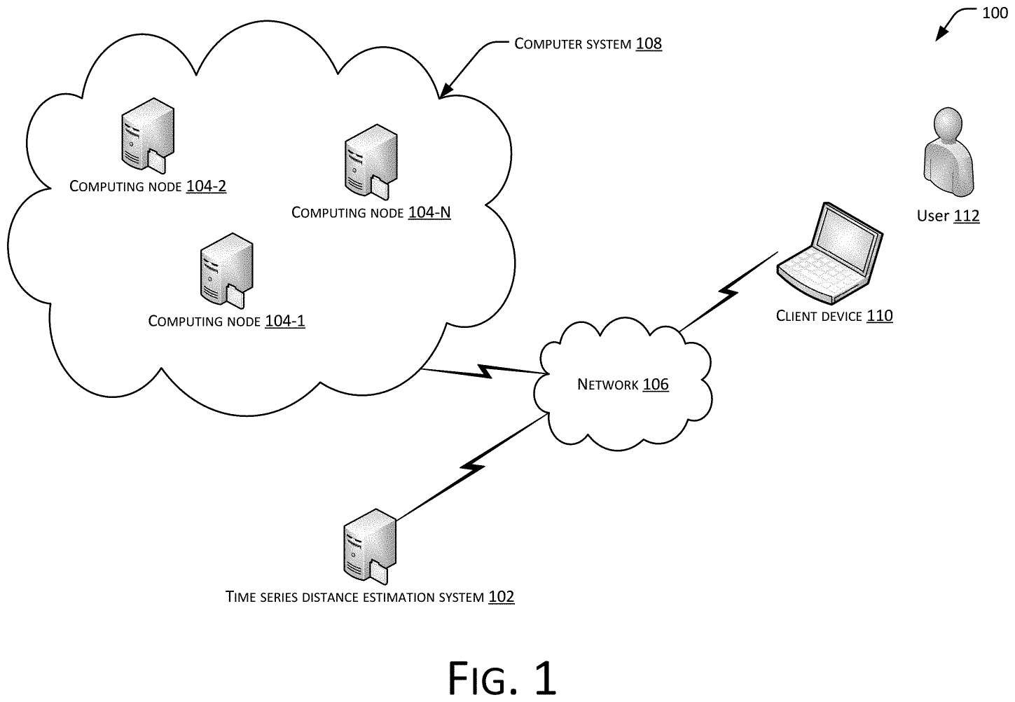

FIG. 1 illustrates an example environment 100 usable to implement a time series distance estimation system. The environment 100 may include a time series distance estimation system 102. In this example, the time series distance estimation system 102 is described to exist as an individual entity or device. In some instances, some or all of the functions of the time series distance estimation system 102 may be included in or provided by a plurality of computing nodes 104-1, 104-2, . . . , 104-N (which are collectively called as computing nodes 104), which are connected and communicated via a network 106, where N is a positive integer. In other instances, the time series distance estimation system 102 may communicate data with the one or more computing nodes 104 via the network 106.

In implementations, the plurality of computing nodes 104 may form a computer system 108 (such as a cloud computing architecture or system), or may form a part of the computer system 108. In implementations, the computer system 108 may provide a variety of services to a plurality of client devices (only one client device 110 is shown in FIG. 1 for the sake of simplicity). In this example, the time series distance estimation system 102 may be described to be a part of the computer system 108. In other instances, the time series distance estimation system 102 may be an individual entity that provides support (such as providing time series distance estimation) to the computer system 108.

In implementations, each of the computing nodes 104 may be implemented as any of a variety of devices having computing capabilities, and may include, but are not limited to, a processor (which may include a single-core processor or a multi-core processor), a desktop computer, a notebook or portable computer, a handheld device, a netbook, an Internet appliance, a tablet or slate computer, a mobile device (e.g., a mobile phone, a personal digital assistant, a smart phone, etc.), a server computer, etc., or a combination thereof.

The network 106 may be a wireless or a wired network, or a combination thereof. The network 106 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. Wired networks may include an electrical carrier connection (such a communication cable, etc.) and/or an optical carrier or connection (such as an optical fiber connection, etc.). Wireless networks may include, for example, a WiFi network, other radio frequency networks (e.g., Bluetooth®, Zigbee, etc.), etc.

In implementations, the time series distance estimation system 102 may receive two time series (i.e., respective pieces of data of the two time series) from the client device 110 of a user 112 or a computing node 104 of the computer system 108. In implementations, each time series may include data obtained or sampled over a period of time, and a type of the data of each time series depends on a type of application to which the time series is used or obtained for. By way of example and not limitation, for speech recognition, the two time series may include sound signals collected or captured by sound receiving devices (such as microphones) for a same group of phrases or a same sentence, and the time series distance estimation system 102 may calculate or estimate a distance or a degree of dissimilarity between the two time series (i.e., the sound signals) to determine whether the sound signals are uttered by the same user or different users.

### Example Time Series Distance Estimation System

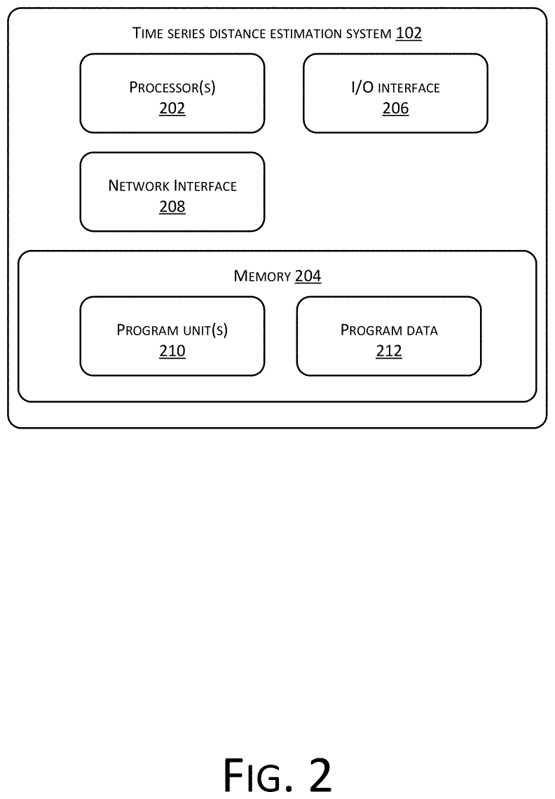

FIG. 2 illustrates the time series distance estimation system 102 in more detail. In implementations, the time series distance estimation system 102 may include, but is not limited to, one or more processors 202, memory 204, an input/output (I/O) interface 206, and/or a network interface 208. In implementations, some of the functions or components of the time series distance estimation system 102 (for example, the one or more processors 202) may be implemented using hardware, for example, an ASIC (i.e., Application-Specific Integrated Circuit), a FPGA (i.e., Field-Programmable Gate Array), and/or other hardware. In this example, the time series distance estimation system 102 may exist as a separate entity which may or may not be associated with a device such as the computing node 104. In some instances, some of the functions of the time series distance estimation system 102 may be included in a device such as the computing node 104.

In implementations, the processors 202 may be configured to execute instructions that are stored in the memory 204, and/or received from the input/output interface 206, and/or the network interface 208. In implementations, the processors 202 may be implemented as one or more hardware processors including, for example, a microprocessor, an application-specific instruction-set processor, a physics processing unit (PPU), a central processing unit (CPU), a graphics processing unit, a digital signal processor, a tensor processing unit, etc. Additionally or alternatively, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc.

The memory 204 may include computer readable media in a form of volatile memory, such as Random Access Memory (RAM) and/or non-volatile memory, such as read only memory (ROM) or flash RAM. The memory 204 is an example of computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include any transitory media, such as modulated data signals and carrier waves.

Although in this example, exemplary hardware components are described in the time series distance estimation system 102, in other instances, the time series distance estimation system 102 may further include other hardware components and/or other software components such as program unit(s) 210 to execute instructions stored in the memory 204 for performing various operations. In implementations, the time series distance estimation system 102 may further include program data 212 that stores data used for performing time series distance estimation.

### Example Robust Dynamic Time Warping Method

In order to enable robustness to noises and outliers while preserving the flexibility of a dynamic index matching or alignment, the time series distance estimation system 102 may employ filtering, such as trend filtering, to effectively filter out noises and outliers included in time series that are compared. In implementations, the time series distance estimation system 102 may estimate a time warp function and detrend time series alternately. In implementations, a dynamic index matching or alignment may include a determination of a mapping between indices (for example, indices of data points such as xᵢ) of one time series x and indices (for example, indices of data points such as yⱼ) of another time series y.

In implementations, the time series distance estimation system 102 may iteratively or recursively perform operations including, but are not limited to: (1) estimating detrended time series (e.g., time series represented by u and v) while keeping a time warp function (e.g., a time warp function represented by φ(t)) fixed; and (2) estimating the time warp function φ(t) based on the time series u and v while keeping the estimated detrended time series u and v fixed. Table 1 below shows a procedure of such alternating method, which steps are described in further detail as follows.

TABLE 1
Robust Dynamic Time Warping (DTW) Method

Input: Input time series (x and y); and regularization parameters λᵢ^{j}
Output: Normalized robust DTW distance

| | |
|---|---|
| Step 1: | Robust Self-Detrending |
| | Normalize x and y |
| | $a = {argmin}_{u} {g}_{γ} ( x , u ) + {λ}_{1}^{self} {‖ {D}^{( 1 )} u ‖}_{1} + {λ}_{2}^{self} {‖ {D}^{( 2 )} u ‖}_{1}$ |
| | $b = {argmin}_{v} {g}_{γ} ( y , v ) + {λ}_{1}^{self} {‖ {D}^{( 1 )} v ‖}_{1} + {λ}_{2}^{self} {‖ {D}^{( 2 )} v ‖}_{1}$ |
| Step 2: | Time Warping Alignment |
| | In the first iteration, use a and b as input for DTW to generate a warping path |
| | In subsequent iterations, use updated u and v for generating a warping path |
| Step 3: | Temporal Graph Detrending |
| | Obtain the warping path generated at Step 2, and update u and v with graph |

detrending as follows:

| | |
|---|---|
| | $u , v = {argmin}_{u , v} \frac{1}{2} {‖ [ u ; v ] - [ a ; b ] ‖}_{2}^{2} + {λ}_{1}^{G D} {‖ {D}_{G}^{( 1 )} [ u ; v ] ‖}_{1} + {λ}_{2}^{G D} {‖ {D}_{G}^{( 2 )} [ u ; v ] ‖}_{1}$ |
| Step 4: | Repeat Steps 2 and 3 until convergence |
| | Repeat Steps 2 and 3 with updated warping path and trend estimates u and v |
| Step 5: | Return result |
| | Use trend estimates u and v and their warping path to obtain a cumulative |

distance, and divide the cumulative distance by the length of the time series.

### Robust Self-Detrending

In implementations, prior to performing time warping, the time series distance estimation system 102 may perform robust trend filtering for each time series to be compared to remove the effects of outliers and noises. In implementations, if a time series of length n (i.e., n time points) is denoted as y=[y₁, y₂, . . . , yₙ]^{T}, the time series distance estimation system 102 may decompose the time series into a trend component and a residual component as follows:

yₜ=τₜ+rₜ or y=τ+r (1)

where τ=[τ₁, τ₂, . . . , τₙ]^{T} denotes the trend component, and r=[r₁, r₂, . . . , rₙ]^{T} denotes the residual component.

In implementations, the time series distance estimation system 102 may apply a detrending filter to detrend the time series. By way of example and not limitation, an example detrending filter that is able to capture both slow and abrupt trend changes while being robust to outliers is used herein for illustrative purpose. Nevertheless, other detrending filters may also be used as long as these detrending filters are able to detect or estimate (and thus filter) one or more trends included in the time series. In implementations, the example detrending filter may extract a trend by minimizing the following objective function:

g_{γ}(y−τ)+λ₁∥D⁽¹⁾τ∥₁+λ₂∥D⁽²⁾τ∥₂ (2)

where g_{γ}(γ−τ)=Σᵢg_{γ}(xᵢ) is a summation of elementwise Huber loss function with each element being:

$${g}_{γ} ( {x}_{i} ) = \{ \begin{matrix}\frac{1}{2} {x}_{i}^{2} & \vert {x}_{i} \vert \leq γ \\ γ \vert {x}_{i} \vert - \frac{1}{2} {γ}^{2} & \vert {x}_{i} \vert > γ\end{matrix} \qquad ( 3 )$$

Furthermore, D⁽¹⁾ ∈ [symbol] ^{(N-1)×N} and D⁽²⁾ ∈ [symbol] ^{(N-2)×N} are a first-order difference matrix and a second-order difference matrix respectively, and are represented as follows:

$${D}^{( 1 )} = [ \begin{matrix}1 & - 1 & & & \\ & 1 & - 1 & & \\ & & & ⋱ & \\ & & & 1 & - 1\end{matrix} ] , {D}^{( 2 )} = [ \begin{matrix}1 & - 2 & 1 & & & \\ & 1 & - 2 & 1 & & \\ & & & ⋱ & & \\ & & & 1 & - 2 & 1\end{matrix} ]$$

In implementations, using the Huber loss enables the example detrending filter to have a better robustness to outliers in the time series as compared to a sum-of-squares loss (though the sum-of-squares loss may also be used instead of the Huber loss for simple calculation), while the first-order difference operator and the second-order difference operator in the regularization terms may capture both abrupt and slow trend changes. After performing the above detrending operations, the two input time series x and y may be written as:

$$u = {argmin}_{u} {g}_{γ} ( x , u ) + {λ}_{1}^{self} {‖ {D}^{( 1 )} u ‖}_{1} + {λ}_{2}^{self} {‖ {D}^{( 2 )} u ‖}_{1}$$

$$v = {argmin}_{v} {g}_{γ} ( y , v ) + {λ}_{1}^{self} {‖ {D}^{( 1 )} v ‖}_{1} + {λ}_{2}^{self} {‖ {D}^{( 2 )} v ‖}_{1}$$

### Time Warping Alignment

In implementations, after performing the self-detrending step or operation on the time series, the time series distance estimation system 102 may apply a dynamic time warping method (such as a FastDTW) on the detrended time series to obtain a time warp function φ(t) (which may correspond to an index mapping from one time series x (indices of one time series x) to another time series y (indices of one time series y)), or a time warping path (which is a set of matrix elements that defines the index mapping, and is used for determining how to stretch the two time series x and y under certain constraints and measuring how dissimilar the two time series x and y after time warping alignment are). In implementations, the dynamic time warping method may include any conventional or future dynamic time warping method that is able to determine a time warp function or an index mapping between two time series (such as a time series x and a time series y) in this example). Examples of the dynamic time warping method may include, but are limited to, a FastDTW method. In implementations, this operation or step of time warping alignment may be extended in a multi-level manner for efficient computation and missing data manipulation, which will be described in detail in a later section.

### Temporal Graph Detrending

In implementations, in order to estimate the detrended time series u and v more accurately, the time series distance estimation system 102 may consider not only data points in one time series, but also data points in another time series, when performing the detrending operation on the time series u and v. For example, in a graph detrending operation, if G=(V, E) is a graph with vertices V={1, . . . , n} and undirected edges E={e₁, . . . , eₛ}, and y=[y₁, . . . , yₙ]^{T}∈Rⁿ over each node, k-th order graph trend filtering estimates τ=[τ₁, . . . , τₙ]^{T} may be obtained by solving:

$${argmin}_{τ ∈ {R}^{n}} \frac{1}{2} {‖ y - τ ‖}_{2}^{2} + λ {‖ {Δ}^{( k + 1 )} τ ‖}_{1} \qquad ( 4 )$$

where Δ^{(k+1)} is a graph difference operator of an order k+1. When k=0, a corresponding 1^{st} order graph difference operator Δ⁽¹⁾ may penalize all local difference on all edges as follows:

∥Δ^{(k+1)}τ∥₁=Σ_{(i,j)∈E}|τᵢ−τⱼ| (5)

In implementations, Δ⁽¹⁾ may be represented in a matrix form as Δ⁽¹⁾∈{−1,0,1}^{s×n}, where s=|E|, i.e., the number of edges. In implementations, if eₗ=(i, j), then Δ⁽¹⁾ has a [symbol] th row:

[symbol]

=[0, . . . ,−1, . . . ,1, . . . ,0] (6)

where [symbol] has −1 at the ith position, 1 at the jth position.

In implementations, similar to trend filtering on univariate time series, higher order graph difference operators may be recursively defined. For example, the graph difference operators defined above may be reduced to the ones defined on the univariate time series in which V={1, 2, . . . , n} and E{(i,i+1): i=1, 2, . . . , n−1}.

In implementations, a general temporal graph detrending for multivariate time series may be designed by extending the graph-based detrending in Equation (4). In implementations, a relationship between time series may be incorporated during detrending, which can also deal with the lagging effect adaptively. Furthermore, a weight (i.e., a binary weight (0 or 1), or a decimal weight having any value within a range of [0, 1]) may be introduced for each edge in the graph.

In implementations, the time series distance estimation system 102 may construct a graph G of two time series x and y that are to be compared based on the time warping alignment at Step 2. By way of example and not limitation, the constructed graph is described to have m+n vertices, and each vertex corresponds to a time point in x∈R^{m} and y∈Rⁿ. For the sake of simplicity, in this example, the set of vertices is denoted as E={x₁, x₂, . . . , xₘ, y₁, y₂, . . . , yₙ}. In implementations, each vertex xₜ (a time point in the time series x) may be connected to its left neighbor xₜ₋₁ and its right neighbor xₜ₊₁ (which are neighboring time points in the time series x). Furthermore, the vertex xₜ may also be connected to its peer vertex (a peer time point, y_{φ(t)}, in the time series y).

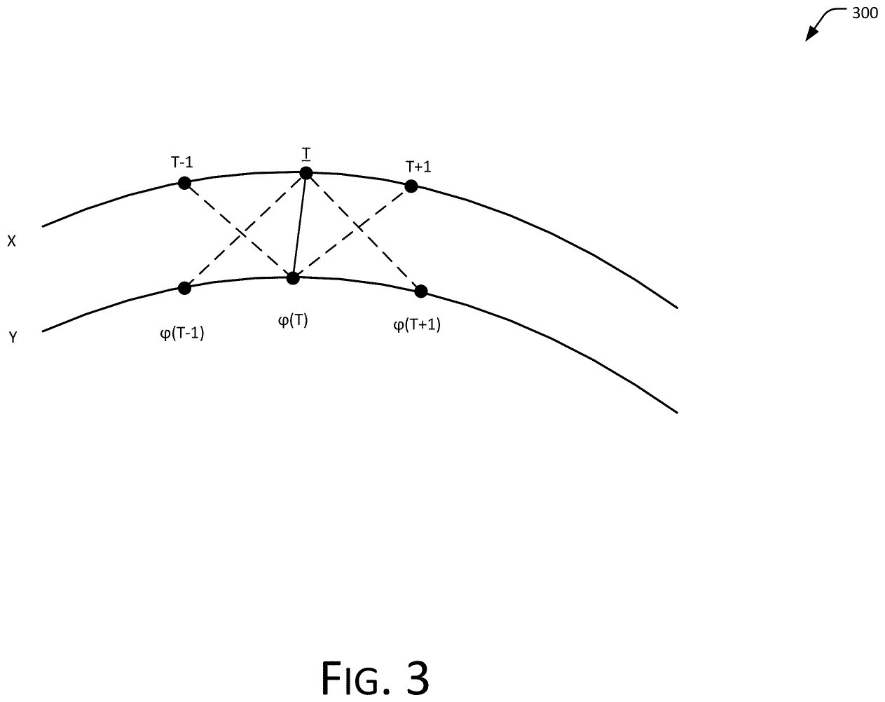

In implementations, in order to avoid errors that may be introduced in the time warping alignment at Step 2, the time series distance estimation system 102 may construct additional or extra edges to improve robustness. For example, given the presence of an edge xₜ<->y_{φ(t)} in the graph G, the time series distance estimation system 102 may add a predetermined number (two, four, six, ten, etc.) of additional edges. In implementations, the predetermined number of additional edges (or the size of neighborhood around xₜ) may depend on noises and outliers included or expected in the time series. FIG. 3 shows an example graph construction 300 between two time series x and y. In this example, the time series distance estimation system 102 may add four additional edges, namely, xₜ<->y_{φ(t)-1}, xₜ<->y_{φ(t)+1}, xₜ₋₁<->y_{φ(t)}, and xₜ₊₁<->y_{φ(t)}, as shown in FIG. 3. Each data point in one time series may be connected not only to its neighbors in the same time series, but also to its peers in another time series. Both time series x and y are aligned by the operation of dynamic time warping at Step 2. As shown in FIG. 3, time stamps on the time series x are t−1, t, t+1. φ(t) is an index mapping from the time series x to the time series y. In this case, data points at time stamps of t−1, t, t+1 on the time series x are aligned or corresponding to data points at time stamps of φ(t)−1, φ(t), φ(t)+1 on the time series y.

In implementations, the time series distance estimation system 102 may assign weights to edges of the constructed graph G. In implementations, the time series distance estimation system 102 may assign different weights to the edges of the constructed graph G. based at least in part on types and/or lengths of the edges. By way of example and not limitation, the time series distance estimation system 102 may assign higher weights to edges connecting neighboring vertices on a same time series, as compared to edges connecting peering vertices on different time series. Additionally, weights for edges between peering vertices on different time series decrease as lengths of the edges between the peering vertices increase (i.e., the peering vertices are increasingly away from the DTW alignment).

In implementations, after the graph G is constructed for the time series (e.g., the time series x and y), the time series distance estimation system 102 may calculate a general temporal graph detrending based on the following equation:

$$u , v = {argmin}_{u , v} \frac{1}{2} {‖ [ u ; v ] - [ a ; b ] ‖}_{2}^{2} + {λ}_{1}^{GD} {‖ {D}_{G}^{( 1 )} [ u ; v ] ‖}_{1} + {λ}_{2}^{GD} {‖ {D}_{G}^{( 2 )} [ u ; v ] ‖}_{1} \qquad ( 7 )$$

where w=[u; v] is a concatenate of input u and v, D_{G}⁽¹⁾ and D_{G}⁽²⁾ are a first-order graph difference operator and a second-order graph difference operator that are defined on the constructed or weighted graph G used for capturing abrupt and slow trend changes respectively.

### Iterative Processing

In implementations, in order to achieve a better performance, the time series distance estimation system 102 may repeat Steps 2 and 3 of the alternating method as described in Table 1 to update the time warp function and the trend estimates until convergence or a predetermined number of iterations (e.g., three iterations, four iterations, . . . , ten iterations, etc.) is reached. In implementations, after convergence or the predetermined number of iterations is reached, the two time series x and y and their alignments may achieve a desirable trade-off, which may not only keep close to original time series (i.e., time series without contamination due to noises and outliers), but also have a final alignment with a lower DTW distance.

Robust Dynamic Time Warping with Multi-Level Framework

In implementations, the time series distance estimation system 102 may take advantage of the similarity of shapes and alignments of the time series among different resolutions, and alternatively perform adjustment of DTW alignment and determination of trend estimates from a low resolution to a high resolution, to further accelerate the speed of computation of the robust dynamic time warping method. In implementations, the time series distance estimation system 102 may use results obtained at a lower resolution as starting values to perform estimations for a higher resolution, and thus a DTW alignment result obtained at the lower resolution can be served as a constraint to limit a path searching space for the higher resolution. Table 2 below shows details of a robust DTW method with a multi-level framework (or simply called as multi-level robust DTW method).

TABLE 2
Robust Dynamic Time Warping (DTW)
Method with Multi-Level Framework

Input: Input time series (x and y); regularization parameters λᵢ^{j}; number of
iterations nₜ; and radius r
Output: Normalized robust DTW distance
Step 1: Robust Self-Detrending at original resolution
Same as Step 1 in Table 1, and results a and b as detrend output for x and
y respectively
Step 2: Multi-Level Representation
Recursively downsample a and b by a predetermined factor (e.g., 2) for nₜ
times, and record intermediate results
Step 3: Projection and Upsampling
In the first iteration, run a DTW method (such as FastDTW) to obtain a
warping path, and use downsampled a and b at the highest level as initial
trend estimates.
In subsequent iterations, upsample DTW warping path with radius r and
trend estimates from a previous level to a current level
Step 4: Time Warping Alignment
Refine warping alignment by a DTW method (such as FastDTW) with
projected constraint obtained from Step 3
Step 5: Temporal Graph Detrending
Generate a graph from updated warping from Step 4 and refine graph
detrending with updated trend estimates, similar to Step 3 in Table 1, at a
corresponding level
Step 6: Repeat Steps 3-5 until lowest level
Step 7: Return result as Step 5 in Table 1

In implementations, as shown in Table 2, the multi-level robust DTW method may include a number of steps, which include but are not limited to, (1) robust self-detrending; (2) multi-level representation; (3) projection and upsampling; (4) time warping alignment by DTW; (5) temporal graph detrending; (6) iterative processing; and (7) normalized distance output.

In implementations, at step (1) (i.e., the step of robust self-detrending), the time series distance estimation system 102 may perform detrending on two time series at the highest resolution (i.e., original resolution without downsampling). In implementations, at step (2) (i.e., the step of multi-level representation), the time series distance estimation system 102 may obtain multi-level representations of the time series by downsampling the detrended time series obtained at step (1) (i.e., the step of robust self-detrending) by a predetermined factor. For example, the detrended time series at the original highest resolution correspond to a level-1 representation, and can be downsampled by a predetermined factor (e.g., two in this example) to generate a level-2 representation. The time series distance estimation system 102 may continue to perform downsampling until a level-nₜ representation is obtained, where nₜ is the total number of different levels (or the number of iterations in Table 2) in the multi-level framework.

In implementations, at step (3) (i.e., the step of projection and upsampling), if a current level is the highest level (i.e., nₜth level), the time series distance estimation system 102 may perform a DTW method (such as FastDTW) on the time series to obtain warping index alignment and use the current level representation as a basis for trend estimation. For a current level (ith level) that is lower than the highest level (i.e., nₜth level), the time series distance estimation system 102 may upsample a warping path obtained for a previous level (i.e., (l+1)th level) by the predetermined factor (i.e., two in this example), and add an additional searching width defined by a parameter (i.e., the radius as shown in Table 2) to generate a searching constraint for the current level, which is called as a projection. In implementations, the time series distance estimation system 102 may further upsample trend estimation obtained at the previous level (i.e., (l+1)th level) for the current level.

In implementations, at step (4) (i.e., the step of time warping alignment by DTW), the time series distance estimation system 102 may refine the warping path obtained at the previous step of projection and upsampling by performing the DTW method at the current level with a projected warping constraint (i.e., the searching constraint generated at the previous step of projection and upsampling). In implementations, at step (5) (i.e., the step of temporal graph detrending), the time series distance estimation system 102 may generate a graph using upsampled trend estimates obtained at the step of projection and upsampling and refined DTW alignment obtained at step 4 (i.e., the step of time warping alignment by DTW). In implementations, the time series distance estimation system 102 may further update the trend estimates based at least in part on the generated graph, and calculate a distance between the two time series at the current level.

In implementations, at step (6) (i.e., the step of iterative processing), the time series distance estimation system 102 may repeat steps (3)-(5) (i.e., the step of projection and upsampling, the step of time warping alignment by DTW, and the step of temporal graph detrending) for nₜ number of times, and reduce the level per iteration until the lowest level of representation (i.e., the original highest resolution) is reached.

### Missing Data Processing

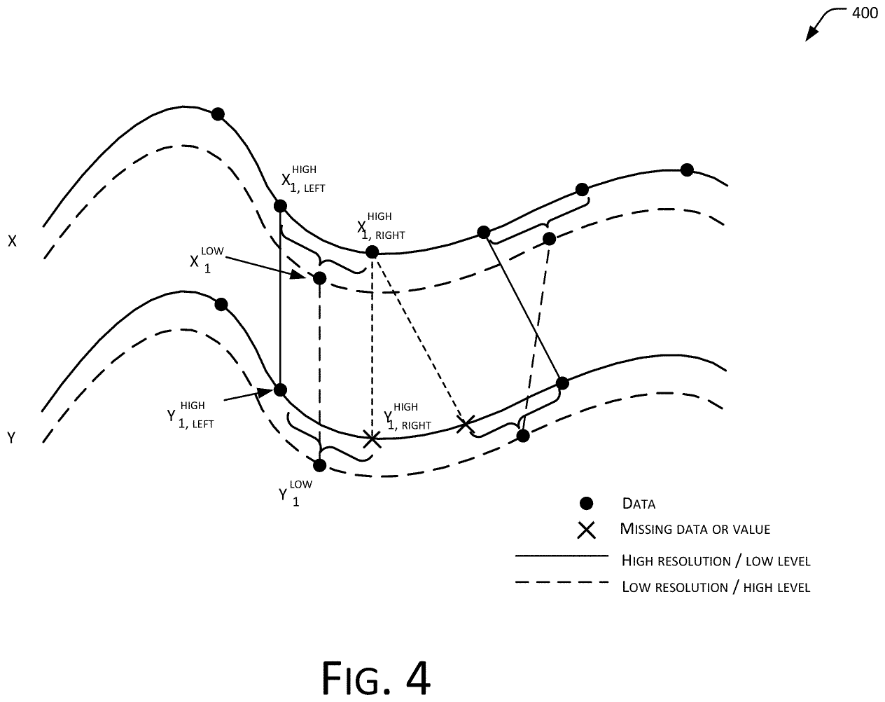

In implementations, the time series distance estimation system 102 may remove all missing values (or data points) with a same time range during DTW computation. However, a data segment including missing values (or data points) in one time series may correspond to another data segment in another time series. FIG. 4 shows an example method 400 of handling missing values in time series in a multi-level framework. In FIG. 4, solid curves represent corresponding data sections of two time series x and y at a higher resolution, and dotted curves represent corresponding data sections of the two time series x and y at a lower resolution. In this example, two data points are said to be missing on the time series y at the higher resolution, and are marked by crosses. If these two data points are not missing, an optimal alignment learned from DTW may align these two data points to their corresponding data points on the time series x at the higher resolution, which are illustrated by two solid straight lines in FIG. 4. In implementations, these missing data points in one time series (such as x_{1,right}^{high} on the time series x at the higher resolution in FIG. 4), which are estimated to align with NaNs (i.e., “Not-a-Number” or undefined or unrepresented values) in another time series (i.e., the time series y at the higher resolution), are desirable to be excluded from alignment calculation.

In implementations, the time series distance estimation system 102 may perform downsampling by a predetermined number (e.g., two), and average the predetermined number of adjacent or neighboring data points (in this example, two adjacent or neighboring data points), recursively for two time series of which a distance or a degree of similarity therebetween is to be determined, until a missing data block disappears (or no data point is missing). By way of example and not limitation, if both the adjacent or neighboring data points have values, the time series distance estimation system 102 may average the predetermined number of adjacent or neighboring data points by taking an arithmetic mean of these two adjacent or neighboring data points. Alternatively, if one of the adjacent or neighboring data points has a value, val, and the other data point has no value (i.e., a missing value), the time series distance estimation system 102 may take val as an average of these two adjacent or neighboring data points. Alternatively, if both the adjacent or neighboring data points have no values (i.e., both having missing value), the time series distance estimation system 102 may take NaN as an average of these two adjacent or neighboring data points.

In implementations, in the lower resolution without missing values, the time series distance estimation system 102 may calculate the DTW, and obtain an alignment. In implementations, to estimate an alignment at the higher resolution, the time series distance estimation system 102 may consider the boundary of values and NaNs. For example, x₁^{low} and y₁^{low} are described to be a pair of aligned points in the lower resolution in the example shown in FIG. 4. In this example, y_{1,left}^{high} is said to have a value and y_{1,right}^{high} is said to be a NaN, while both x_{1,left}^{high} and x_{1,right}^{high} are described to have values. In this case, the time series distance estimation system 102 may heuristically estimate an alignment between two corresponding data points in the time series x and y by finding a minimum of |x_{1,left}^{high}−y_{1,left}^{high}| and |x_{1,right}^{high}−y_{1,right}^{high}|. In this example, if |x_{1,left}^{high}−y_{1,left}^{high}| is smaller, the time series distance estimation system 102 may align x_{1,left}^{high} with y_{1,left}^{high} in the higher resolution. Following this rule, the time series distance estimation system 102 may estimate an alignment in the boundary of NaN blocks in the higher resolution, and thus can remove a missing data segment of one time series and its aligned counterpart on another time series. The time series distance estimation system 102 may apply this procedure to multiple missing data segments or value blocks on both time series.

### Example Method

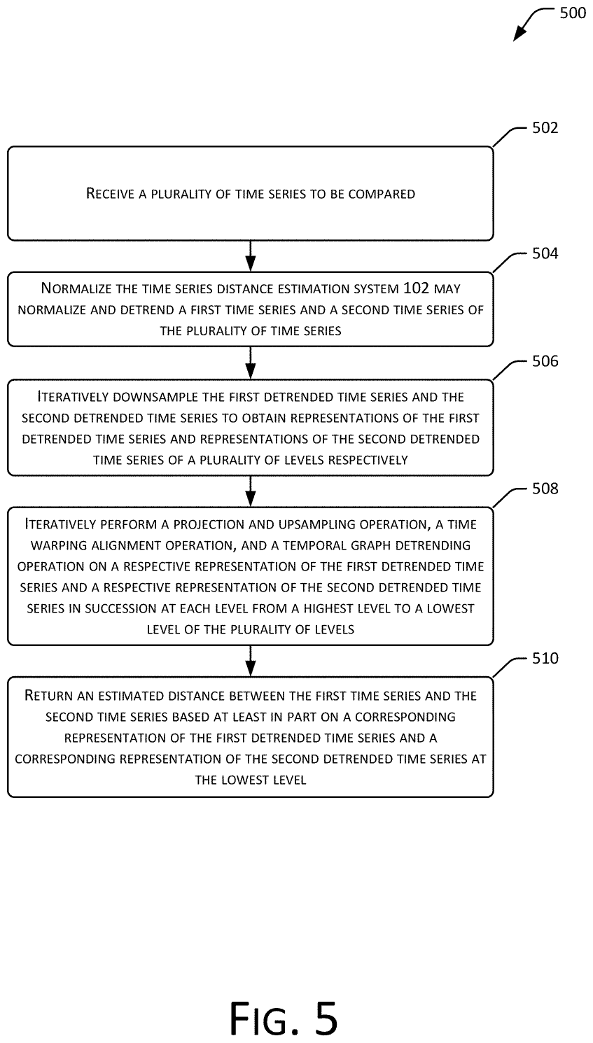

FIG. 5 shows a schematic diagram depicting an example method of time series distance estimation. The method of FIG. 5 may, but need not, be implemented in the environment of FIG. 1, and using the system of FIG. 2. For ease of explanation, method 500 is described with reference to FIGS. 1 and 2. However, the method 500 may alternatively be implemented in other environments and/or using other systems.

The method 500 is described in the general context of computer-executable instructions. Generally, computer-executable instructions can include routines, programs, objects, components, data structures, procedures, modules, functions, and the like that perform particular functions or implement particular abstract data types. Furthermore, each of the example methods are illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 5, at block 502, the time series distance estimation system 102 may receive a plurality of time series to be compared.

In implementations, the time series distance estimation system 102 may receive a plurality of time series to be compared, for example, a first time series and a second time series. The first time series and the second time series may include or correspond to two signals that are obtained over different periods of time for an application and are compared to determine whether the two signals are considered to be identical or come from a same source. In implementations, examples of the application may include, but are not limited to, speech recognition, speaker recognition, machine learning, signal processing, robotics, and bioinformatics. For example, the first time series and the second time series may include or correspond to two sound signals that are obtained over different periods of time for an application and are compared to determine whether the two signals are spoken by a same speaker (i.e., come from a same source).

At block 504, the time series distance estimation system 102 may normalize and detrend a first time series and a second time series of the plurality of time series.

In implementations, the time series distance estimation system 102 may perform normalization and detrending on a first time series and a second time series of the plurality of time series to obtain a first detrended time series and a second detrended time series. In implementations, the time series distance estimation system 102 may perform trend filtering (such as applying a detrending filter with a Huber loss function) to remove respective trend components and noise components from the first time series and the second time series.

At block 506, the time series distance estimation system 102 may iteratively downsample the first detrended time series and the second detrended time series to obtain representations of the first detrended time series and representations of the second detrended time series of a plurality of levels respectively.

In implementations, the time series distance estimation system 102 may recursively perform downsampling by a predetermined factor (such as two, etc.) to obtain different levels of representations of each time series of the first detrended time series and representations of the second detrended time series. In implementations, the time series distance estimation system 102 may predetermine a number of levels (i.e., a number of applications of downsampling) for the first detrended time series and the second detrended time series. In implementations, the time series distance estimation system 102 may predetermine the number of levels based on, for example, original lengths of the first detrended time series and the second detrended time series. By way of example and not limitation, the number of levels may be larger when the original lengths of the first detrended time series and the second detrended time series are longer.

At block 508, the time series distance estimation system 102 may iteratively perform a projection and upsampling operation, a time warping alignment operation, and a temporal graph detrending operation on a respective representation of the first detrended time series and a respective representation of the second detrended time series in succession at each level from a highest level to a lowest level of the plurality of levels.

In implementations, after downsampling the first detrended time series and the second detrended time series to obtain representations of the first detrended time series and representations of the second detrended time series of the plurality of levels, the time series distance estimation system 102 may iteratively perform a number of different operations on a respective representation of the first detrended time series and a respective representation of the second detrended time series in succession at each level from a highest level to a lowest level of the plurality of levels. In implementations, the number of operations may include, but are not limited to, a projection and upsampling operation, a time warping alignment operation, and a temporal graph detrending operation.

For example, for a current level of the plurality of levels, the time series distance estimation system 102 may successively perform different operations (such as a projection and upsampling operation, a time warping alignment operation, and a temporal graph detrending operation) on a respective representation of the first detrended time series and a respective representation of the second detrended time series at that current level.

In implementations, the time series distance estimation system 102 may perform a projection and upsampling operation on a representation of the first detrended time series and a representation of the second detrended time series at a current level. For example, if the current level is the highest level, the time series distance estimation system 102 may perform dynamic time warping on the representation of the first detrended time series and the representation of the second detrended time series at the current level to obtain a warping path between the representation of the first detrended time series and the representation of the second detrended time series.

In implementations, if the current level is a level lower than the highest level, the time series distance estimation system 102 may perform upsampling a warping path between a representation of the first detrended time series and a representation of the second detrended time series at a previous level that is higher than the current level to obtain a new warping path for the current level, and generating a searching constraint for the current level. Additionally, the time series distance estimation system 102 may perform upsampling trend estimates obtained at the previous level for the current level.

In implementations, after performing the projection and upsampling operation for the current level, the time series distance estimation system 102 may perform the time warping alignment operation. By way of example and not limitation, the time series distance estimation system 102 may refine the new warping path by performing dynamic time warping at the current level with the searching constraint.

In implementations, after performing the time warping alignment operation for the current level, the time series distance estimation system 102 may perform the temporal graph detrending operation. In implementations, the time series distance estimation system 102 may generate a graph using the upsampled trend estimates and the refined warping path. Additionally, the time series distance estimation system 102 may update the trend estimates for the current level based at least in part on the generated graph, and calculate a distance between the representation of the first detrended time series and the representation of the second detrended time series at the current level.

In implementations, the time series distance estimation system 102 may further perform a missing data processing operation on the first detrended time series and the second detrended time series. In implementations, the time series distance estimation system 102 may remove a missing data segment of the first time series and an aligned counterpart data segment of the second time series, and vice versa.

At block 510, the time series distance estimation system 102 may return an estimated distance between the first time series and the second time series based at least in part on a corresponding representation of the first detrended time series and a corresponding representation of the second detrended time series at the lowest level.

In implementations, after iteratively performing the number of different operations on a respective representation of the first detrended time series and a respective representation of the second detrended time series in succession at each level from the highest level to the lowest level of the plurality of levels, the time series distance estimation system 102 may return a final distance between a representation of the first detrended time series and a representation of the second detrended time series obtained at the lowest level as an estimated distance or degree of dissimilarity between the first time series and the second time series. In implementations, the time series distance estimation system 102 may further send the estimated distance or degree of dissimilarity to the application (such as speech recognition, speaker recognition, machine learning, signal processing, robotics, and bioinformatics, etc.) for which the first time series and the second time series are obtained and used, so that the application may perform subsequent processing based at least in part on the estimated distance or degree of dissimilarity.

Since the robust dynamic time warping method has been described in detail in the foregoing description, reference can be made to the foregoing description for additional details of operations (such as the projection and upsampling operation, the time warping alignment operation, the temporal graph detrending operation, the missing data processing operation, etc.) performed by the method 500 described herein.

Although the above method blocks are described to be executed in a particular order, in some implementations, some or all of the method blocks can be executed in other orders, or in parallel.

### CONCLUSION

Although implementations have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, FPGAs, or other hardware.

The present disclosure can be further understood using the following clauses.

Clause 1: A method implemented by one or more computing devices, the method comprising: detrending a first time series and a second time series; iteratively downsampling the first detrended time series and the second detrended time series to obtain representations of the first detrended time series and representations of the second detrended time series of a plurality of levels respectively; iteratively performing a projection and upsampling operation, a time warping alignment operation, and a temporal graph detrending operation on a respective representation of the first detrended time series and a respective representation of the second detrended time series in succession at each level from a highest level to a lowest level of the plurality of levels; and returning an estimated distance between the first time series and the second time series based at least in part on a corresponding representation of the first detrended time series and a corresponding representation of the second detrended time series at the lowest level.

Clause 2: The method of Clause 1, further comprising performing normalization on the first time series and the second time series prior to detrending the first time series and the second time series.

Clause 3: The method of Clause 1, wherein a current level is the highest level, and performing the projection and upsampling operation at each level from the highest level to the lowest level of the plurality of levels comprises: performing dynamic time warping on a representation of the first detrended time series and a representation of the second detrended time series at the current level to obtain a warping path between the representation of the first detrended time series and the representation of the second detrended time series.

Clause 4: The method of Clause 1, wherein a current level is a level lower than the highest level, and performing the projection and upsampling operation at each level from the highest level to the lowest level of the plurality of levels comprises: upsampling a warping path between a representation of the first detrended time series and a representation of the second detrended time series at a previous level that is higher than the current level to obtain a new warping path for the current level, and generating a searching constraint for the current level; and upsampling trend estimates obtained at the previous level for the current level.

Clause 5: The method of Clause 4, wherein performing the time warping alignment operation at each level from the highest level to the lowest level of the plurality of levels comprises: refining the new warping path by performing dynamic time warping at the current level with the searching constraint.

Clause 6: The method of Clause 5, wherein performing the temporal graph detrending operation at each level from the highest level to the lowest level of the plurality of levels comprises: generating a graph using the upsampled trend estimates and the refined warping path; updating the trend estimates for the current level based at least in part on the generated graph; and calculating a distance between the representation of the first detrended time series and the representation of the second detrended time series at the current level.

Clause 7: The method of Clause 1, further comprising: removing a missing data segment of the first time series and an aligned counterpart data segment of the second time series.

Clause 8: The method of Clause 1, wherein the first time series and the second time series comprise two signals that are obtained over different periods of time for an application and are compared to determine whether the two signals are considered to be identical or come from a same source.

Clause 9: The method of Clause 8, wherein the application comprises at least one of speech recognition, speaker recognition, machine learning, signal processing, robotics, and bioinformatics.

Clause 10: One or more computer readable media storing executable instructions that, when executed by one or more processors, cause the one or more processors comprising: detrending a first time series and a second time series; iteratively downsampling the first detrended time series and the second detrended time series to obtain representations of the first detrended time series and representations of the second detrended time series of a plurality of levels respectively; iteratively performing a projection and upsampling operation, a time warping alignment operation, and a temporal graph detrending operation on a respective representation of the first detrended time series and a respective representation of the second detrended time series in succession at each level from a highest level to a lowest level of the plurality of levels; and returning an estimated distance between the first time series and the second time series based at least in part on a corresponding representation of the first detrended time series and a corresponding representation of the second detrended time series at the lowest level.

Clause 11: The one or more computer readable media of Clause 10, the acts further comprising performing normalization on the first time series and the second time series prior to detrending the first time series and the second time series.

Clause 12: The one or more computer readable media of Clause 10, wherein a current level is the highest level, and performing the projection and upsampling operation at each level from the highest level to the lowest level of the plurality of levels comprises: performing dynamic time warping on a representation of the first detrended time series and a representation of the second detrended time series at the current level to obtain a warping path between the representation of the first detrended time series and the representation of the second detrended time series.

Clause 13: The one or more computer readable media of Clause 10, wherein a current level is a level lower than the highest level, and performing the projection and upsampling operation at each level from the highest level to the lowest level of the plurality of levels comprises: upsampling a warping path between a representation of the first detrended time series and a representation of the second detrended time series at a previous level that is higher than the current level to obtain a new warping path for the current level, and generating a searching constraint for the current level; and upsampling trend estimates obtained at the previous level for the current level.

Clause 14: The one or more computer readable media of Clause 13, wherein performing the time warping alignment operation at each level from the highest level to the lowest level of the plurality of levels comprises: refining the new warping path by performing dynamic time warping at the current level with the searching constraint.

Clause 15: The one or more computer readable media of Clause 14, wherein performing the temporal graph detrending operation at each level from the highest level to the lowest level of the plurality of levels comprises: generating a graph using the upsampled trend estimates and the refined warping path; updating the trend estimates for the current level based at least in part on the generated graph; and calculating a distance between the representation of the first detrended time series and the representation of the second detrended time series at the current level.

Clause 16: A system comprising: one or more processors; and memory storing executable instructions that, when executed by one or more processors, cause the one or more processors comprising: detrending a first time series and a second time series; iteratively downsampling the first detrended time series and the second detrended time series to obtain representations of the first detrended time series and representations of the second detrended time series of a plurality of levels respectively; iteratively performing a projection and upsampling operation, a time warping alignment operation, and a temporal graph detrending operation on a respective representation of the first detrended time series and a respective representation of the second detrended time series in succession at each level from a highest level to a lowest level of the plurality of levels; and returning an estimated distance between the first time series and the second time series based at least in part on a corresponding representation of the first detrended time series and a corresponding representation of the second detrended time series at the lowest level.

Clause 17: The system of Clause 16, the acts further comprising performing normalization on the first time series and the second time series prior to detrending the first time series and the second time series.

Clause 18: The system of Clause 16, wherein a current level is the highest level, and performing the projection and upsampling operation at each level from the highest level to the lowest level of the plurality of levels comprises: performing dynamic time warping on a representation of the first detrended time series and a representation of the second detrended time series at the current level to obtain a warping path between the representation of the first detrended time series and the representation of the second detrended time series.

Clause 19: The system of Clause 16, wherein a current level is a level lower than the highest level, and performing the projection and upsampling operation at each level from the highest level to the lowest level of the plurality of levels comprises: upsampling a warping path between a representation of the first detrended time series and a representation of the second detrended time series at a previous level that is higher than the current level to obtain a new warping path for the current level, and generating a searching constraint for the current level; and upsampling trend estimates obtained at the previous level for the current level.

Clause 20: The system of Clause 19, wherein performing the time warping alignment operation at each level from the highest level to the lowest level of the plurality of levels comprises: refining the new warping path by performing dynamic time warping at the current level with the searching constraint.

What is claimed is:

1. A method implemented by one or more computing devices, the method comprising:
detrending a first time series and a second time series;
iteratively downsampling the first detrended time series and the second detrended time series to obtain representations of the first detrended time series and representations of the second detrended time series of a plurality of levels respectively;
iteratively performing a projection and upsampling operation, a time warping alignment operation, and a temporal graph detrending operation on a respective representation of the first detrended time series and a respective representation of the second detrended time series in succession at each level from a highest level to a lowest level of the plurality of levels; and
returning an estimated distance between the first time series and the second time series based at least in part on a corresponding representation of the first detrended time series and a corresponding representation of the second detrended time series at the lowest level.

2. The method of claim 1, further comprising performing normalization on the first time series and the second time series prior to detrending the first time series and the second time series.

3. The method of claim 1, wherein a current level is the highest level, and performing the projection and upsampling operation at each level from the highest level to the lowest level of the plurality of levels comprises:
performing dynamic time warping on a representation of the first detrended time series and a representation of the second detrended time series at the current level to obtain a warping path between the representation of the first detrended time series and the representation of the second detrended time series.

4. The method of claim 1, wherein a current level is a level lower than the highest level, and performing the projection and upsampling operation at each level from the highest level to the lowest level of the plurality of levels comprises:
upsampling a warping path between a representation of the first detrended time series and a representation of the second detrended time series at a previous level that is higher than the current level to obtain a new warping path for the current level, and generating a searching constraint for the current level; and
upsampling trend estimates obtained at the previous level for the current level.

5. The method of claim 4, wherein performing the time warping alignment operation at each level from the highest level to the lowest level of the plurality of levels comprises: refining the new warping path by performing dynamic time warping at the current level with the searching constraint.

6. The method of claim 5, wherein performing the temporal graph detrending operation at each level from the highest level to the lowest level of the plurality of levels comprises:
generating a graph using the upsampled trend estimates and the refined warping path;
updating the trend estimates for the current level based at least in part on the generated graph; and
calculating a distance between the representation of the first detrended time series and the representation of the second detrended time series at the current level.

7. The method of claim 1, further comprising: removing a missing data segment of the first time series and an aligned counterpart data segment of the second time series.

8. The method of claim 1, wherein the first time series and the second time series comprise two signals that are obtained over different periods of time for an application and are compared to determine whether the two signals are considered to be identical or come from a same source.

9. The method of claim 8, wherein the application comprises at least one of speech recognition, speaker recognition, machine learning, signal processing, robotics, and bioinformatics.

10. One or more computer readable media storing executable instructions that, when executed by one or more processors, cause the one or more processors comprising:
detrending a first time series and a second time series;
iteratively downsampling the first detrended time series and the second detrended time series to obtain representations of the first detrended time series and representations of the second detrended time series of a plurality of levels respectively;
iteratively performing a projection and upsampling operation, a time warping alignment operation, and a temporal graph detrending operation on a respective representation of the first detrended time series and a respective representation of the second detrended time series in succession at each level from a highest level to a lowest level of the plurality of levels; and
returning an estimated distance between the first time series and the second time series based at least in part on a corresponding representation of the first detrended time series and a corresponding representation of the second detrended time series at the lowest level.

11. The one or more computer readable media of claim 10, the acts further comprising performing normalization on the first time series and the second time series prior to detrending the first time series and the second time series.

12. The one or more computer readable media of claim 10, wherein a current level is the highest level, and performing the projection and upsampling operation at each level from the highest level to the lowest level of the plurality of levels comprises:
performing dynamic time warping on a representation of the first detrended time series and a representation of the second detrended time series at the current level to obtain a warping path between the representation of the first detrended time series and the representation of the second detrended time series.

13. The one or more computer readable media of claim 10, wherein a current level is a level lower than the highest level, and performing the projection and upsampling operation at each level from the highest level to the lowest level of the plurality of levels comprises:
upsampling a warping path between a representation of the first detrended time series and a representation of the second detrended time series at a previous level that is higher than the current level to obtain a new warping path for the current level, and generating a searching constraint for the current level; and
upsampling trend estimates obtained at the previous level for the current level.

14. The one or more computer readable media of claim 13, wherein performing the time warping alignment operation at each level from the highest level to the lowest level of the plurality of levels comprises:
refining the new warping path by performing dynamic time warping at the current level with the searching constraint.

15. The one or more computer readable media of claim 14, wherein performing the temporal graph detrending operation at each level from the highest level to the lowest level of the plurality of levels comprises:
generating a graph using the upsampled trend estimates and the refined warping path;
updating the trend estimates for the current level based at least in part on the generated graph; and
calculating a distance between the representation of the first detrended time series and the representation of the second detrended time series at the current level.

16. A system comprising:
one or more processors; and
memory storing executable instructions that, when executed by one or more processors, cause the one or more processors comprising:
detrending a first time series and a second time series;
iteratively downsampling the first detrended time series and the second detrended time series to obtain representations of the first detrended time series and representations of the second detrended time series of a plurality of levels respectively;
iteratively performing a projection and upsampling operation, a time warping alignment operation, and a temporal graph detrending operation on a respective representation of the first detrended time series and a respective representation of the second detrended time series in succession at each level from a highest level to a lowest level of the plurality of levels; and
returning an estimated distance between the first time series and the second time series based at least in part on a corresponding representation of the first detrended time series and a corresponding representation of the second detrended time series at the lowest level.

17. The system of claim 16, the acts further comprising performing normalization on the first time series and the second time series prior to detrending the first time series and the second time series.

18. The system of claim 16, wherein a current level is the highest level, and performing the projection and upsampling operation at each level from the highest level to the lowest level of the plurality of levels comprises:
performing dynamic time warping on a representation of the first detrended time series and a representation of the second detrended time series at the current level to obtain a warping path between the representation of the first detrended time series and the representation of the second detrended time series.

19. The system of claim 16, wherein a current level is a level lower than the highest level, and performing the projection and upsampling operation at each level from the highest level to the lowest level of the plurality of levels comprises:
upsampling a warping path between a representation of the first detrended time series and a representation of the second detrended time series at a previous level that is higher than the current level to obtain a new warping path for the current level, and generating a searching constraint for the current level; and
upsampling trend estimates obtained at the previous level for the current level.

20. The system of claim 19, wherein performing the time warping alignment operation at each level from the highest level to the lowest level of the plurality of levels comprises:
refining the new warping path by performing dynamic time warping at the current level with the searching constraint.
